(19) United States
(12) Patent Application Publication
(10) Pub. No.: US 2016/0070632 A1
(43) Pub. Date: Mar. 10, 2016

(54) POWER PROFILING METHOD, POWER PROFILING SYSTEM, AND PROCESSOR-READABLE STORAGE MEDIUM

(71) Applicant: SAMSUNG ELECTRONICS CO., LTD., Suwon-Si (KR)

(72) Inventors: RAE-SEOK KIM, Goyang-Si (KR); BYUNG-WOO BANG, Hwaseong-Si (KR); JUN-YOUNG YU, Seoul (KR)

(21) Appl. No.: 14/752,872

(22) Filed: Jun. 27, 2015

(30) Foreign Application Priority Data
Sep. 5, 2014 (KR) 10-2014-0119368

(51) Int. Cl. G06F 11/30

(52) U.S. Cl. CPC G06F 11/3062

(57) ABSTRACT

A power profiling method, a power profiling system, and a processor-readable storage medium are provided. The power profiling method includes collecting power status information indicating software and hardware statuses of a power domain that operates in a target board according to input test control information, and generating analysis information of power that is consumed by the target board using the collected power status information.

### CROSS-REFERENCE TO RELATED APPLICATION

The present application claims priority to and the benefit of Korean Patent Application No. 10-2014-0119368, filed on Sep. 5, 2014, in the Korean Intellectual Property Office, the entire contents of which are incorporated by reference herein.

### BACKGROUND

The present disclosure relates to a method and an apparatus for analyzing power, and, more particularly, to a power profiling method, a power profiling system, and a processor-readable storage medium.

As semiconductor technology has developed, the size of a device utilizing semiconductor technology has been reduced and operational speed has increased. As such, it has been an important issue to reduce power consumption. For mobile devices using a battery, a solution for a low-power design has become necessary. Accordingly, in order to develop a solution for a low-power designs, a solution for monitoring and optimizing power-related software and hardware in a product development stage has become necessary.

### SUMMARY

The inventive concepts of the present disclosure provide a power profiling method of monitoring and optimizing power-related software and hardware in a product development stage.

The inventive concepts of the present disclosure also provide a power profiling system for monitoring and optimizing power-related software and hardware in a product development stage.

The inventive concepts of the present disclosure also provide a processor-readable storage medium having embodied thereon a program code for executing a power profiling method of monitoring and optimizing power-related software and hardware in a product development stage.

According to an aspect of the inventive concepts of the present disclosure, there is provided a power profiling method including collecting power status information indicating software and hardware statuses of a power domain that operates in a target board according to input test control information, and generating analysis information of power that is consumed by the target board using the collected power status information.

According to another aspect of the inventive concepts of the present disclosure, there is provided a power profiling system including an embedded system board configured to collect power status information indicating software and hardware statuses according to input test control information, and configured to transmit the power status information to a test management unit. A power measurement unit is connected to a power line of the embedded system board, calculates power consumption measurement information of at least one power domain and transmits the calculated power consumption measurement information to the test management unit. The test management unit that is connected to the embedded system board and the power monitoring unit, transmits the test control information based upon a power test scenario to the embedded system board and generates power test reporting information by combining the power status information and the power consumption measurement information.

According to another aspect of the inventive concepts of the present disclosure, there is provided a processor-readable storage medium having embodied thereon program code for executing a power profiling method including collecting power status information indicating software and hardware statuses of a power domain that operates in a target board according to input test control information, and generating analysis information of power that is consumed by the target board using the collected power status information.

### BRIEF DESCRIPTION OF THE DRAWINGS

FIG. 1 is a block diagram illustrating a power profiling system according to an exemplary embodiment;

FIG. 2 is a detailed block diagram illustrating an embedded system board of FIG. 1, according to an exemplary embodiment;

FIG. 3 is a detailed block diagram illustrating the embedded system board of FIG. 1, according to an exemplary embodiment;

FIG. 4 is a detailed block diagram illustrating a power measurement unit of FIG. 1, according to an exemplary embodiment;

FIG. 5 is a detailed block diagram illustrating a voltage measurer of FIG. 4, according to an exemplary embodiment;

FIG. 6 is a detailed block diagram illustrating a test management unit of FIG. 1, according to an exemplary embodiment;

FIGS. 7, 8, 9 and 10 are screen images of the power profiling system, according to exemplary embodiments;

FIG. 11 is a block diagram illustrating a power profiling system according to an exemplary embodiment;

FIG. 12 is a diagram explaining power profiling performed by a power profiling system, according to an exemplary embodiment;

FIG. 13 is a flowchart of a power profiling method according to an exemplary embodiment;

FIG. 14 is a flowchart of a power profiling method according to an exemplary embodiment; and

FIG. 15 is a block diagram illustrating an electronic apparatus to which an embedded system board is applied, according to an exemplary embodiment.

### DETAILED DESCRIPTION OF THE EMBODIMENTS

The inventive concepts disclosed herein will now be described more fully with reference to the accompanying drawings, in which exemplary embodiments of the inventive concepts of the present disclosure are shown. The inventive concepts may, however, be embodied in many different forms and should not be construed as being limited to the embodiments set forth herein. Rather, these exemplary embodiments are provided so that this disclosure will be thorough and complete, and will fully convey the inventive concepts of the present disclosure to those skilled in the art. It should be understood, however, that there is no intent to limit exemplary embodiments to the particular forms disclosed, but conversely, exemplary embodiments are to cover all modifications, equivalents, and alternatives falling within the spirit and scope of the inventive concepts of the present disclosure. Like reference numerals denote like elements in the drawings. In the attached drawings, sizes of structures may be exaggerated for clarity.

The terminology used herein is for the purpose of describing exemplary embodiments only and is not intended to be limiting of exemplary embodiments of the inventive concepts of the present disclosure. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “and/or” includes any and all combinations of one or more of the associated listed items. Expressions such as “at least one of,” when preceding a list of elements, modify the entire list of elements and do not modify the individual elements of the list.

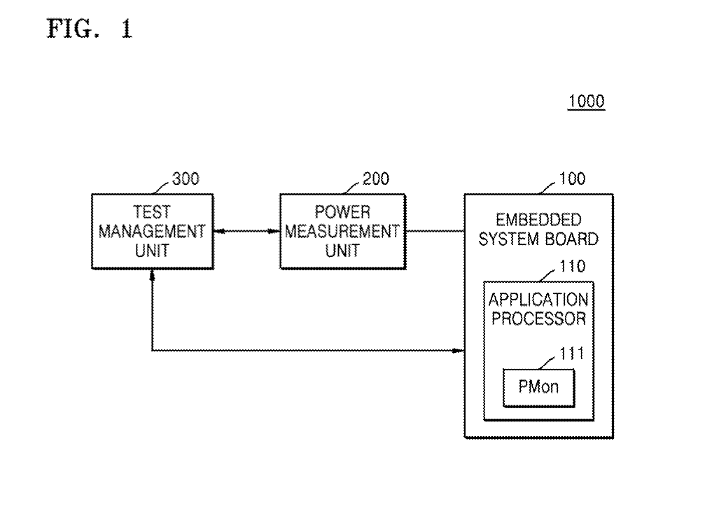

FIG. 1 is a block diagram illustrating a power profiling system 1000 according to an exemplary embodiment.

Referring to FIG. 1, the power profiling system 1000 may include an embedded system board 100, a power measurement unit 200, and a test management unit 300.

The embedded system board 100 may be an electronic control system board embedded in an electronic product in order to form the electronic product having a specific function, and may include a combination of hardware and software for performing a predetermined specific function. For example, the embedded system board 100 may be embedded in the electronic product such as a mobile device, a notebook computer, or a camera.

The embedded system board 100 may include an application processor 110. The application processor 110 may perform operations such as driving various application programs, processing sound, and processing graphics. For example, the application processor 110 may be realized as a system on chip (SoC) in which various functions such as an audio codec processing function, a graphics processing function, and a multimedia processing function are integrated into one SoC. Alternatively, the application processor 110 may be realized as a chipset including a plurality of chips. Each functional block may be performed in an intellectual property (IP) or device. Also, each functional block may be performed by a virtual device.

A power monitoring application program PMon 111 may be used to collect power status information indicating software and hardware statuses of a power domain that operates in the embedded system board 100, and the power monitoring application program PMon 111 may be stored in the application processor 110.

The embedded system board 100 may include a plurality of power domains each of which may independently perform a power gating operation in order to reduce power consumption by shutting off power to hardware that is not in use. For example, the power domain may be separated according to types of functional blocks. Alternatively, two or more functional blocks may be combined to constitute one power domain.

When the power monitoring application program PMon 111 is executed in the embedded system board 100, power status information indicating software and hardware operation statuses related to power consumption of the embedded system 100 can be collected.

For example, the power status information may include software and hardware power gating status information related to power that is supplied to at least one device embedded in the embedded system board 100. The power status information may include software and hardware power gating status information of the power domain that operates according to input test control information. The embedded system board 100 may receive test control information from the test management unit 300. For example, the test control information may be received as a command. Alternatively, the test control information may be received as a control signal.

In more detail, the software power gating status information may include status information of software that instructs a gating operation on the power that is supplied to at least one device. Also, the software power gating status information may include status information of software that instructs a gating operation on power that is supplied to at least one power domain.

The hardware power gating status information may include status information of a control signal for operating a gating circuit that supplies the power to at least one device. Also, the hardware power gating status information may include status information of a control signal for operating a gating circuit that supplies the power to at least one power domain.

For example, the power status information may include status information of at least one processor embedded in the application processor 110. The status information of at least one processor may include activation status information of multi-core central processing units (CPUs) embedded in at least one processor. The status information of at least one processor may include operating frequency information of at least one processor.

For example, the power status information may include temperature measurement information of at least one measurement point on the embedded system board 100. In more detail, one measurement point may be determined according to each power domain. Alternatively, a device of which temperature is expected to increase may be determined as a measurement point.

The power measurement unit 200 may be connected to a power line of the embedded system board 100, calculate power consumption measurement information of at least one power domain, and transmit the calculated power consumption measurement information to the test management unit 300.

For example, the power measurement unit 200 may measure current that flows in a power line according to each power domain, and may calculate power consumption measurement information according to each power domain, using the measured current. The calculated power consumption measurement information can indicate power consumption of the power domain in real time.

Alternatively, the power measurement unit 200 may measure current that flows in a power line of each main power domain, and may calculate power consumption measurement information according to each main power domain, using the measured current. The calculated power consumption measurement information can indicate power consumption of the power domain in real time.

The test management unit 300 may be connected to the embedded system board 100 and the power measurement unit 200 through a wired interface or a wireless interface.

The test management unit 300 may transmit the test control information based upon a power test scenario to the embedded system board 100, and may receive the power status information from the embedded system board 100. Also, the test management unit 300 may receive the power consumption measurement information from the power measurement unit 200. The power test scenario may refer to a scenario that sets a process of measuring power consumption of main power domains according to the order in which functional blocks of the embedded system board 100 operate.

Examples of the power test scenario of the embedded system board 100 that is applied to a mobile device are as follows:

[Power test scenario 1]

Home→Video Play→3D Game→MP3 Play→Camera→Home

[Power test scenario 2]

Home→MP3 Play→Home→Internet→Home→Video Play→Home

The test management unit 300 may generate power test reporting information by combining the power status information and the power consumption measurement information that are received from the embedded system board 100 and the power measurement unit 200, respectively. In more detail, the test management unit 300 can generate power analysis information of hardware and software of the embedded system board 100 by combining the power status information and the power consumption measurement information.

The test management unit 300 may generate analysis information for detecting a power design error of the software and the hardware by processing the received power status information. For example, the test management unit 300 may compare a software power gating status and a hardware power gating status of a target power domain that operates according to the test control information, and can generate analysis information indicating whether the software power gating status and the hardware power gating status are the same.

When the software power gating status and the hardware power gating status of the target power domain are the same, analysis information indicating “PASS’ may be generated, and otherwise, analysis information indicating “FAIL” may be generated. In more detail, when both the software power gating status and the hardware power gating status of the target power domain indicate “ON”, analysis information indicating “PASS” may be generated.

When the software power gating status of the target power domain indicates “ON” and the hardware power gating status of the target power domain indicates “OFF”, analysis information indicating “FAIL” may be generated. In this case, it is indicated that the application processor 110 of the target power domain of the embedded system board 100 does not normally operate.

Also, even when at least one selected from a software power gating status and a hardware power gating status of a power domain of which an operation is not allowed according to the test control information indicates “ON”, analysis information indicating “FAIL” may be generated. In this case, it is determined that although the power domain is designed to be maintained in a power off status, since one of the software power gating status and the hardware power gating status of the power domain actually indicates “ON”, the application processor 110 of the power domain does not normally operate.

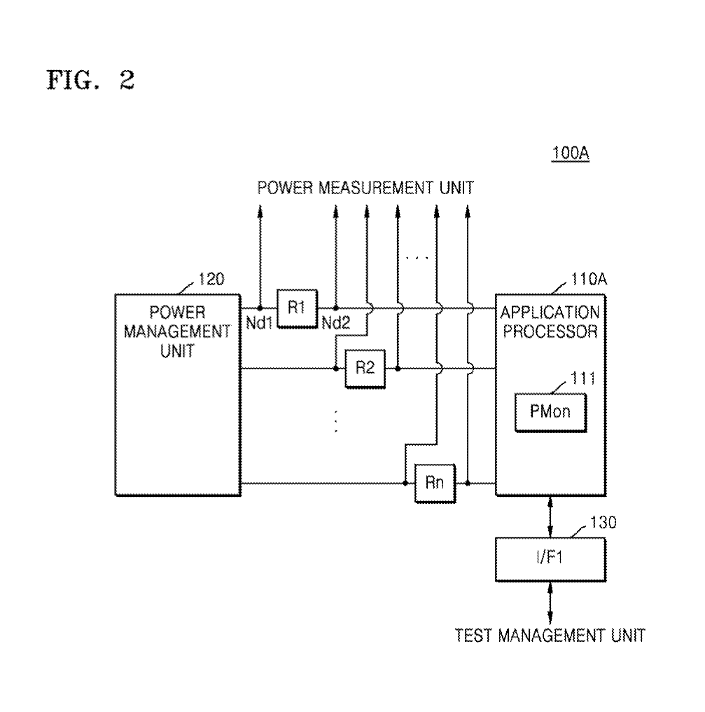

FIG. 2 is a detailed block diagram illustrating an embedded system board 100A of FIG. 1, according to an exemplary embodiment.

Referring to FIG. 2, the embedded system board 100A may include an application processor 110A, a power management unit 120, and a first interface 130.

The power management unit 120 may supply and manage power that is needed by the embedded system board 100A. The power management unit 120 may supply power to each of a plurality of power domains of the embedded system board 100A. In more detail, the power management unit 120 may supply power to each of a plurality of power domains of the application processor 110A. For example, the power management unit 120 may supply independent power to each of power domains that are separated according to types of functional blocks of the application processor 110A. The term “independent power” refers to power that may allow power gating irrespective of other power lines. That is, the independent power refers to power that may switch power supply.

As shown in FIG. 2, the power management unit 120 may supply a plurality of pieces of power to the application processor 110A through shunt resistors R1, R2, . . . Rn according to power domains. That is, a circuit is configured so that one shunt resistor is inserted according to each power line that is generated by the power management unit 120. The shunt resistors R1, R2, . . . Rn may be resistors having low resistance values that are used to calculate current flowing in power lines.

The application processor 110A may generally control an electronic device in which the embedded system 100A is embedded, and may perform various functions by driving various application programs. The application processor 110 may include a combination of hardware and software for performing a preset specific function. The application processor 110A may be realized as an SoC in which various functions such as an audio codec processing function, a graphics processing function, and a multimedia processing function are integrated into one. Alternatively, the application processor 110A may be realized as a chipset including a plurality of chips.

The power monitoring application program PMon 111 may be used to collect power status information indicating software and hardware statuses of a power domain that operates in the embedded system board 100A, and the power monitoring application program PMon 111 may be stored in the application processor 110A. The power monitoring application program PMon 111 may be a Linux application program that scans and collects information of a Linux virtual device, and may transmit the scanned and collected information to the test management unit 300 that corresponds to a host.

The application processor 110A may include a plurality of power domains each of which may independently perform a power gating operation. For example, the power domains may be separated according to types of functional blocks of the application processor 110A.

The application processor 110A may collect power status information indicating software and hardware statuses according to each power domain by executing the power monitoring application program PMon 111.

The application processor 110A may collect power status information by executing the power monitoring application program PMon 111 as follows.

The application processor 110A may collect software and hardware power gating status information related to power that is supplied to at least one device embedded in the embedded system board 100A. For example, the application processor 110A may collect software and hardware power gating status information of a power domain that operates according to input test control information.

In more detail, the application processor 110A may collect status information of software that instructs a gating operation on power that is supplied to at least one power domain. Also, the application processor 110A may collect status information of a control signal for operating a gating circuit that supplies the power to at least one power domain.

The application processor 110A may collect status information of at least one embedded processor. In more detail, the application processor 110A may collect activation status information of multi-core CPUs. Also, the application processor 110A may collect operating frequency information of at least one embedded processor.

The application processor 110A may collect temperature measurement information of at least one measurement point on the embedded system board 100A.

The first interface 130 may include a data exchange protocol with the test management unit 300 that is connected to the embedded system board 100A, and may perform interfacing between the embedded system board 100A and the test management unit 300. Examples of the first interface 130 may include, but are not limited to, an advanced technology attachment (ATA) interface, a serial advanced technology attachment (SATA) interface, a parallel advanced technology attachment (PATA) interface, a universal serial bus (USB) or serial attached small computer system (SAS) interface, a small computer system interface (SCSI), an embedded multimedia card (eMMC) interface, a universal flash storage (UFS) interface, an Ethernet interface, or the like.

The application processor 110A may receive the test control information based upon a power test scenario from the test management unit 300 through the first interface 130. The application processor 110A may transmit the power status information that is collected in real time to the test management unit 300 through the first interface 130.

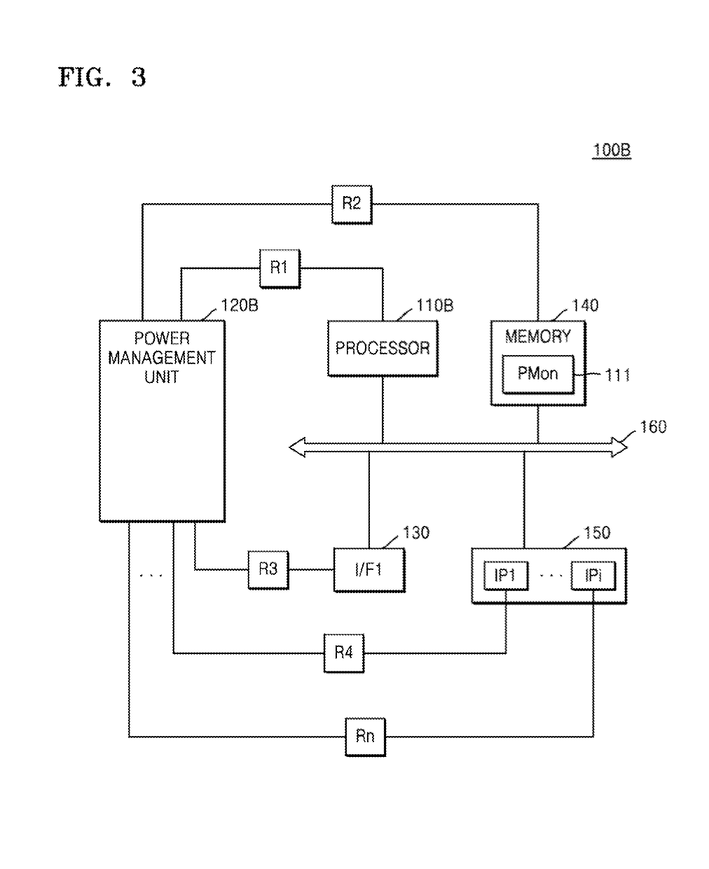

FIG. 3 is a detailed block diagram illustrating an embedded system board 100B of FIG. 1, according to an exemplary embodiment.

Referring to FIG. 3, the embedded system board 100B may include a processor 110B, a power management unit 120B, the first interface 130, a memory 140, an IP block 150, and a bus 160.

The power management unit 120B may supply and manage power that is needed by the embedded system board 100B. The power management unit 120B may supply power to each of a plurality of power domains of the embedded system board 100B. In more detail, the power management unit 120B may supply independent power to the processor 110B, the first interface 130, the memory 140, and the IP block 150. For example, the power management unit 120B may supply different pieces of power to a plurality of IPs IP1, IP2, . . . IPi that are included in the IP block 150. Alternatively, IPs having a high correlation among the plurality of IPs IP1, IP2, . . . IPi included in the IP block 150 may constitute one power domain. For example, since the possibility that an IP having a sound processing function and an IP having a video processing function operate together is high, the IP having the sound processing function and the IP having the video processing function may constitute one power domain. The power management unit 120B may supply power voltages through the shunt resistors R1, R2, . . . Rn according to the power domains.

The processor 110B may be connected to the elements of the embedded system board 100B through the bus 160. The processor 110B may include program codes and circuits for controlling operations of the elements of the embedded system board 100B. For example, the processor 110B may include a CPU, an ARM microarchitecture processor, or an application specific integrated circuit (ASIC).

The memory 140 may be a static random access memory (SRAM) or a dynamic random access memory (DRAM) that stores data, commands, or program codes needed to operate the embedded system board 100B. Also, the memory 140 may be a nonvolatile memory. Program codes that may be used to execute one or more operating systems and virtual machines may be stored in the memory 140. Also, program codes that execute a hypervisor for managing the virtual machines may be stored in the memory 140. The power monitoring application program PMon 111 may be stored in the memory 140.

The IP block 150 may include the plurality of IPs IP1, IP2, . . . IPn that perform specific functions. For example, the IP block 150 may include an IP having an audio codec processing function, an IP having a graphics processing function, and an IP having a 3D video processing function.

The first interface 130 has already been explained with reference to FIG. 2, and thus a repeated explanation thereof will not be given.

The processor 110B may collect power status information indicating software and hardware statuses according to each power domain of the embedded system board 100B by executing the power monitoring application program PMon 111 that is stored in the memory 140.

In more detail, the processor 110B may collect software and hardware power gating status information related to power supplied to at least one IP that is included in the IP block 150. For example, the processor 110B may collect software and hardware power gating status information of a power domain that operates according to input test control information.

In more detail, the processor 110B may collect status information of software that instructs a gating operation on power that is supplied to at least one power domain. Also, the processor 110B may collect status information of a control signal for operating a gating circuit that supplies the power to at least one power domain.

The processor 110B may collect status information of one or more embedded core CPUs. In more detail, the processor 110B may collect activation status information of multi-core CPUs. Also, the processor 110B may collect operating frequency information of the processor 110B.

The processor 110B may collect temperature measurement information of at least one measurement point on the embedded system board 100B.

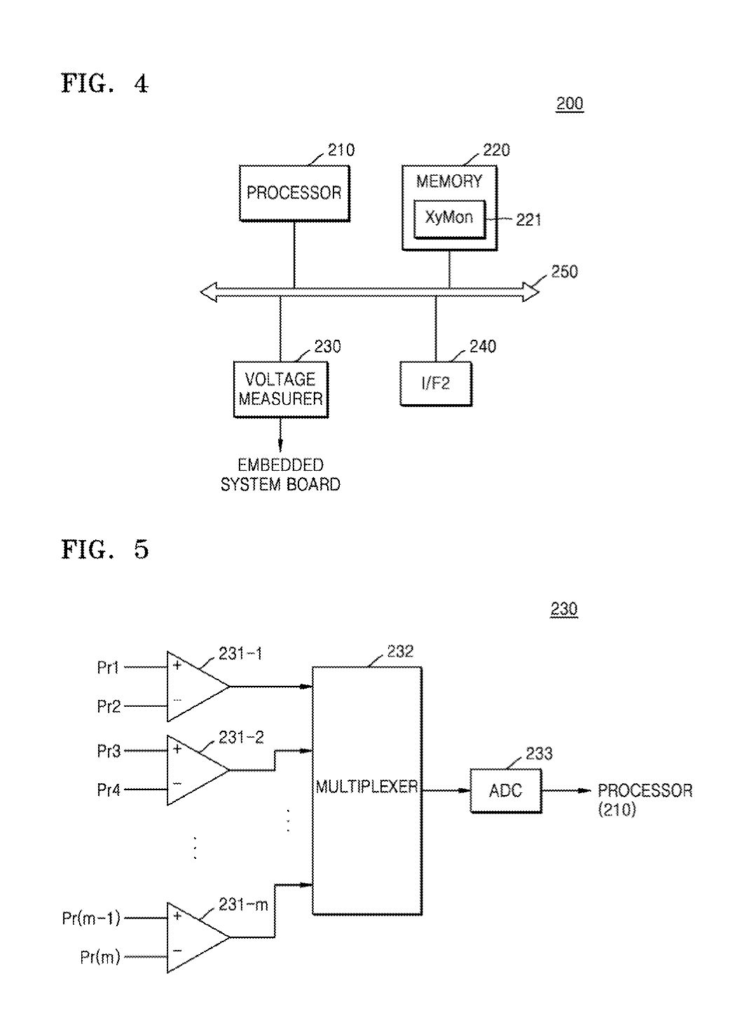

FIG. 4 is a detailed block diagram illustrating the power measurement unit 200 of FIG. 1, according to an exemplary embodiment.

Referring to FIG. 4, the power measurement unit 200 may include a processor 210, a memory 220, a voltage measurer 230, a second interface 240, and a bus 250.

The processor 210 may be connected to the elements of the power measurement unit 200 through the bus 250. The processor 210 may include program codes and circuits for controlling operations of the elements of the power measurement unit 200.

The memory 220 may be an SRAM or a DRAM that stores data, commands, or program codes that are needed to operate the power measurement unit 200. Also, the memory 220 may be a nonvolatile memory. A power measurement application program XyMon 221 may be stored in the memory 220.

The voltage measurer 230 may connect measurement probes to both terminals of a shunt resistor that is inserted into a power line of each of power domains of the embedded system boards 100A, 100B. The voltage measurer 230 may measure a voltage between both ends of the shunt resistor that is inserted into the power line according to each power domain. For example, the voltage measurer 230 may measure a voltage signal between both ends of a shunt resistor inserted into a power line of power that is supplied to some power domains among the power domains of the embedded system boards 100A, 100B. For example, the voltage measurer 230 may convert an analog voltage signal measured between the both ends of the shunt resistor into digital data. Alternatively, the processor 210 may convert an analog voltage measured between the both ends of the shunt resistor into digital data.

The processor 210 may calculate current flowing in a power line according to each power domain from the digital data by executing the power measurement application program XyMon 221 that is stored in the memory 220. In more detail, since a resistance value of the shunt resistor that is inserted into the power line according to each power domain of the embedded system boards 100A, 100B is known, the current flowing in the power line may be obtained by dividing a voltage measured between the both ends of the shunt resistor by the resistance value of the shunt resistor.

The processor 210 may calculate a power consumption value of the power domain by multiplying the current flowing in the power line according to each power domain by the voltage of the power line.

Data about the calculated power consumption value according to each power domain may be transmitted to the test management unit 300 through the second interface 240.

The second interface 240 may include a data exchange protocol with the test management unit 300 that is connected to the power measurement unit 200, and may perform interfacing between the power measurement unit 200 and the test management unit 300. Examples of the second interface 240 may include, but are not limited to, an ATA interface, a SATA interface, a PATA interface, a USB or SAS interface, a SCSI, an eMMC interface, a UFS interface, and an Ethernet interface.

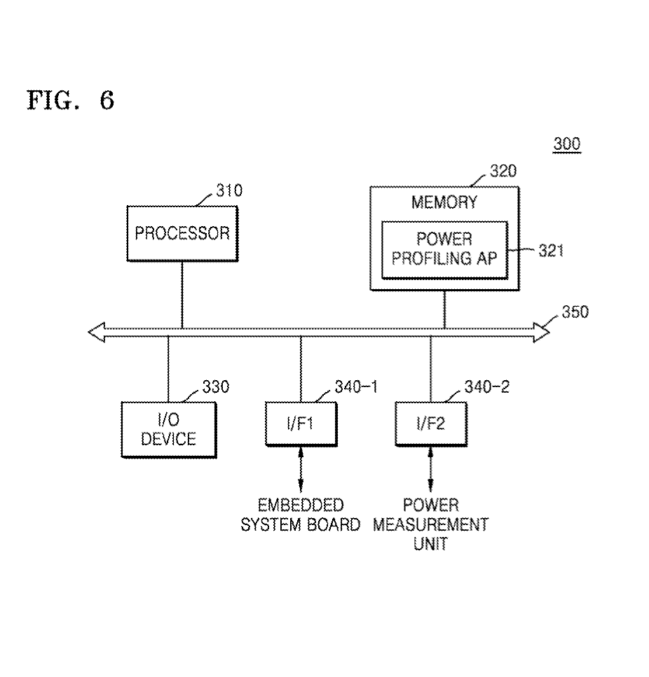

FIG. 5 is a detailed block diagram illustrating the voltage measurer 230 of FIG. 4, according to an exemplary embodiment.

Referring to FIG. 5, the voltage measurer 230 may include a plurality of differential amplifiers 231-1, 231-2, . . . 231-m, a multiplexer 232, and an analog-to-digital converter 233.

Each of the plurality of differential amplifiers 231-1, 231-2, . . . 231-m may monitor a voltage between both ends of a shunt resistor inserted into a power line of a power domain.

Both terminals of a shunt resistor inserted into a power line of power that is supplied to one power domain of which power consumption is to be measured may be connected to a positive (+) input terminal and a negative (−) input terminal of each of the plurality of differential amplifiers 231-1, 231-2, . . . 231-m.

For example, referring to FIG. 2, when the differential amplifier 231-1 monitors a voltage between both ends of the shunt resistor RI in a power domain of a power line into which the shunt resistor R1 is inserted, a positive (+) input terminal may be connected to a node Nd1 of the power line through a probe Prl and a negative (−) input terminal may be connected to a node Nd2 of the power line through a probe Pr2.

Alternatively, in the power domain of the power line into which the shunt resistor R1 is inserted, the positive (+) input terminal may be connected to the node Nd2 of the power line through the probe Prl and the negative (−) input terminal may be connected to the node Ndl of the power line through the probe Pr2.

The differential amplifier 231-1 may output a voltage signal that is proportional to the voltage between the both ends of the shunt resistor R1. That is, a voltage signal obtained by multiplying the voltage between the both ends of the shunt resistor R1 by a gain of the differential amplifier 231-1 may be output. For example, when the gain of the differential amplifier 231-1 is set to “1”, a voltage signal corresponding to the voltage between the both ends of the shunt resistor R1 may be output.

Each of the other differential amplifiers 231-2, . . . 231-m may monitor a voltage between both ends of a shunt resistor inserted into a power line of a power domain, in the same manner as described for the differential amplifier 231-1. ‘m’ corresponds to the number of power domains whose power consumption may be simultaneously monitored. For example, when ‘m’ is set to 8, the voltage measurer 230 may need 8 differential amplifiers and may simultaneously monitor power consumption of 8 power domains.

The multiplexer 232 may sequentially select output signals of the plurality of differential amplifiers 231-1, 231-2, . . . 231-m, and may output the selected output signals to the analog-to-digital converter 233.

The analog-to-digital converter 233 may convert an analog signal that is input from the multiplexer 232 into digital data. The digital data output from the analog-to-digital converter 233 may be output to the processor 210 of the power measurement unit 200 in order to calculate power consumption.

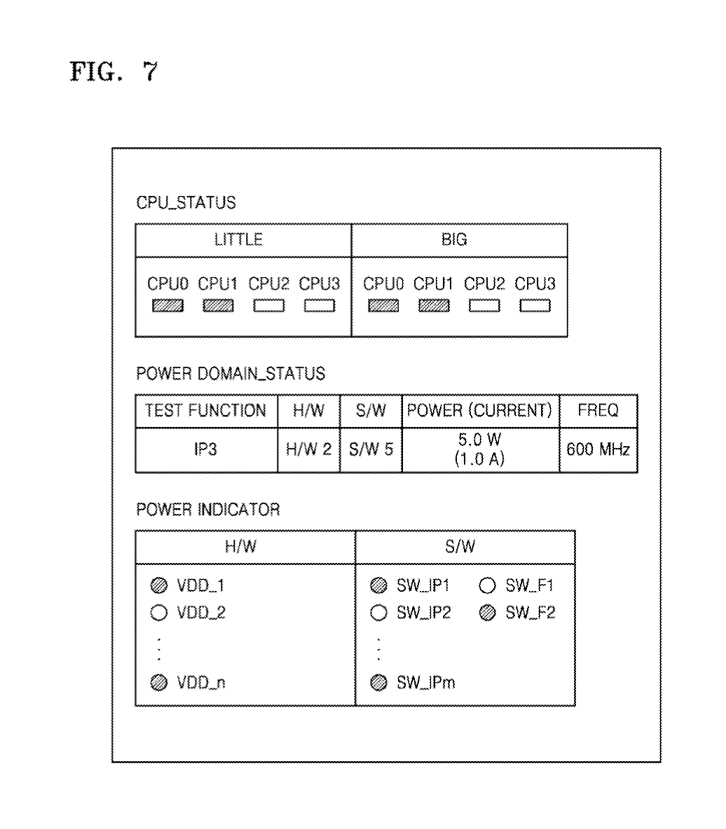

FIG. 6 is a detailed block diagram illustrating the test management unit 300 of FIG. 1, according to an exemplary embodiment.

Referring to FIG. 6, the test management unit 300 may include a processor 310, a memory 320, an input/output device 330, first and second interfaces 340-1, 340-2, and a bus 350.

The processor 310 may be connected to the elements of the test management unit 300 through the bus 350. The processor 310 may include program codes and circuits for controlling operations of the elements of the test management unit 300.

The processor 310 may perform specific calculations or tasks. For example, the processor 310 may be a microprocessor or a CPU. The processor 310 may communicate with the memory 320, the input/output device 330, and the first and second interfaces 340-1, 340-2 through the bus 350 such as an address bus, a control bus, or a data bus. According to embodiments, the processor 310 may be connected to an extension bus such as a peripheral component interconnect (PCI) bus.

The memory 320 may be an SRAM or a DRAM that stores data, commands, or program codes that are needed to operate the test management unit 300. Also, the memory 320 may be a nonvolatile memory. A power profiling application program 321 may be stored in the memory 320.

The input/output device 330 may include an input unit such as a keyboard, a keypad, or a mouse and an output unit such as a printer or a display.

The processor 310 may perform mathematical operations or data processing corresponding to a user command that is input through the input/output device 330. The processor 310 may generate test control information based upon a power test scenario that is set according to the user command by executing the power profiling application program 321. The processor 310 may transmit the generated test control information to a target board of which power is to be tested through the first interface 340-1. For example, the target board may be the embedded system board 100. The power test scenario may be set in order to monitor software and hardware power gating statuses and to monitor power consumption in each specific function mode. For example, a user may set the power test scenario through the input/output device 330. The power test scenario may be set to operate functional blocks in various orders, and a plurality of the power test scenarios may be set.

The processor 310 may generate power test reporting information for power analysis by combining power status information and power consumption measurement information that are received from the embedded system board 100 and the power measurement unit 200, respectively, by executing the power profiling application program 321.

The processor 310 may generate power analysis information of hardware and software of the embedded system board 100 by combining the power status information and the power consumption measurement information.

The processor 310 may generate analysis information for detecting a power design error of the software and the hardware by processing the power status information. For example, the processor 310 may compare the software power gating status and the hardware power gating status of the target power that operates in the embedded system board 100 according to the test control information, and may generate analysis information indicating whether the software power gating status and the hardware power gating status are the same.

For example, when both a software power gating status and a hardware power gating status of a power domain including a 3D game functional block in a power test scenario period for which a 3D game function is performed in the embedded system board 100 are monitored to indicate “ON”, the processor 310 may generate analysis information indicating “PASS”, and otherwise, the processor 310 may generate analysis information indicating “FAIL”.

When both the software power gating status and the hardware power gating status of the power domain including the 3D game functional block in the embedded system block 100 in the power test scenario period for which the 3D game function is performed are monitored to indicate “OFF”, the processor 310 may determine that an error occurs in hardware and software of the 3D game functional block.

When the software power gating status and the hardware power gating status of the power domain including the 3D game functional block in the embedded system board 100 in the power test scenario period for which the 3D game function is performed are monitored to respectively indicate “ON” and “OFF”, the processor 310 may determine that the software of the 3D game functional block normally operates and an error occurs in the hardware of the 3D game functional block.

The processor 310 may generate analysis information indicating “FAIL” even when at least one selected from a software power gating status and a hardware power gating status of a power domain of which an operation is not allowed according to the test control information indicates “ON”. In this case, it is determined that although the power domain is designed to be maintained in a power off status, since one of the software power gating status and the hardware power gating status actually indicates “ON”, the power domain abnormally operates.

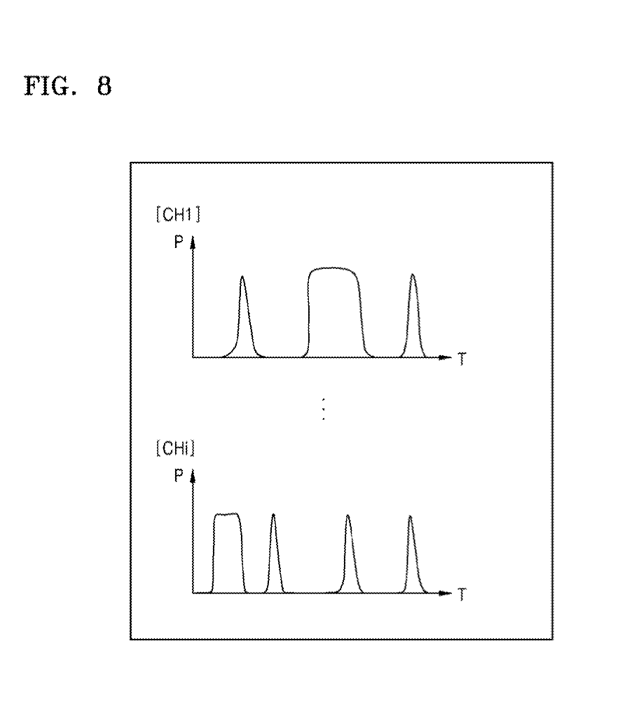

The processor 310 may perform graphics processing on the power test reporting information and may output a result of the graphics processing to the input/output device 330. For example, the processor 310 may perform graphics processing on the power test reporting information to obtain web type information or console type information, and may output the web type information or the console type information to the input/output device 330. Various screen images that are output after graphics processing is performed on the power test reporting information will now be explained with reference to FIGS. 7-10.

FIGS. 7-10 are screen images of the power profiling system 1000, according to exemplary embodiments.

FIG. 7 is a screen image illustrating a CPU status in the embedded system board 100, a power domain status of a test IP, and software and hardware power statuses, according to an exemplary embodiment.

A display area CPU_STATUS may be an area indicating a CPU that operates in a specific function period of a test scenario from among multi-cores. For example, the display area CPU_STATUS indicates a CPU that is activated from among a plurality of little CPUs and big CPUs. In FIG. 7, little CPUs CPU0, CPU1 and big CPUs CPU0, CPU1 operate, and little CPUs CPU2, CPU3 and big CPUs CPU2, CPU3 are each in a sleep status.

A display area POWER DOMAIN_STATUS may be an area indicating a test function of a test period for which a test is performed in a test scenario, hardware and software that operate in the test period, a power consumption value (or current) of a power domain, and an operating frequency. In FIG. 7, the hardware that is executed while the test function is performed on IP3 is H/W2 and the software that is executed while the test function is performed is S/W5. FIG. 7 also shows the operating frequency and the power consumption value while the test function is performed on the IP3. For example, the power consumption value may be a maximum value or an average value.

A display area POWER INDICATOR may be an area indicating a hardware power status and a software power status in the test period for which the test is performed in the test scenario. In FIG. 7, hardware powers VDD_1, VDD_n are each in a power gating status of “ON” and hardware power VDD_2 is in a power gating status of “OFF”. Software powers SW_IP1, SW_IPm, SW_F2 are each in a power gating status of “ON” and software powers SW_IP2, SW_F1 are each in a power gating status of “OFF”. For example, the hardware power VDD_1, VDD_2, . . . VDD_n may be power voltages that are supplied to a plurality of power domains of the embedded system board 100. The software powers SW_IP1, SW_IP2, . . . SW_IPm, SW_F1, SW_F2 may be software related to operations of IP blocks and peripheral devices of the embedded system board 100.

FIG. 8 is a screen image illustrating real time power consumption of main power domains in the embedded system board 100, according to an exemplary embodiment.

FIG. 8 illustrates power consumption values of the main power domains measured in real time according to a period for which a specific function is performed based upon a test scenario, according to an exemplary embodiment. For example, FIG. 8 is a graph illustrating a relationship between real time power consumption of i power domains through channel 1, . . . channel i (i is an integer equal to or greater than 2). In the graph, T represents a time and P represents power consumption.

Alternatively, a screen image illustrating real time current flowing in the main power domains while the specific function is performed based upon the test scenario, may be added.

FIG. 9 is a screen image illustrating a display area POWER GATING_STATUS that compares and analyzes a software power gating status and a hardware power gating status in the embedded system board 100, according to an exemplary embodiment.

FIG. 9 illustrates a software power gating status and a hardware power gating status of each of main IP blocks in a power test scenario period for which a specific function is performed, according to an exemplary embodiment.

For example, it is assumed that in a power test scenario period for which a 3D game function is performed, an IP IP3 may operate and other IPs may not operate. In this case, since both a software power gating status and a hardware power gating status of the IP IP3 are monitored to indicate “ON”, a power gating status of the IP3 may be displayed as “PASS”. Since both a software power gating status and a hardware power gating status of an IP2 are monitored to indicate “OFF”, a power gating status of an IP IP2 may be displayed as “PASS”. However, since a software power gating status of the IP IP1 indicates “OFF” but a hardware power gating status of the IP IP1 indicates “ON”, a power gating status of the IP IP1 may be displayed as “FAIL”.

FIG. 10 is a screen image illustrating temperature measurement information of main measurement points on the embedded system board 100, according to an exemplary embodiment.

FIG. 10 illustrates temperature values measured at main measurement points TP1, TP2 on the embedded system board 100 that operates based upon a power test scenario, according to an exemplary embodiment.

For example, the various monitoring screen images of the power profiling system 1000 of FIGS. 7-10 may be integrated into one screen image and may be displayed. Alternatively, some of the monitoring screen images of the power profiling system 1000 of FIGS. 7-10 may be modified or integrated and displayed.

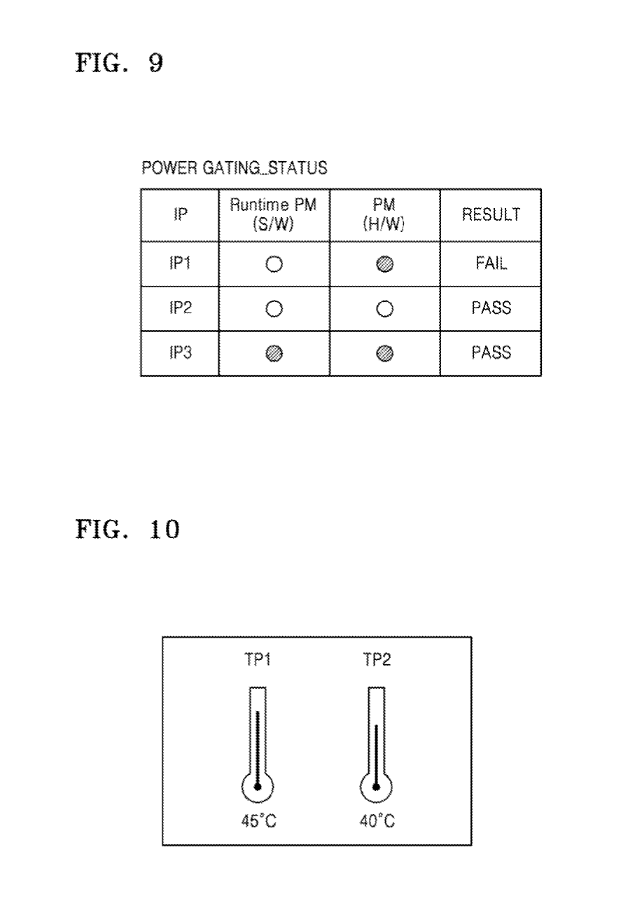

FIG. 11 is a block diagram illustrating a power profiling system 2000 according to an exemplary embodiment.

Referring to FIG. 11, the power profiling system 2000 may include hardware 2100, a power monitoring application module PMon 2200, a power measurement application module XyMon 2300, an interface 2400, and a power profiling application module 2500.

The hardware 2100 may refer to hardware that is embedded in a target board whose power is to be tested. For example, the hardware 2100 may include hardware in the application processor 110 of the embedded system board 1000 of FIG. 1. In more detail, the hardware 2100 may include IP blocks IPI 2110-1, IP2 2110-2, . . . IPi 2110-i in the application processor 110 of the embedded system board 1000.

The power monitoring application module PMon 2200 may include a measurement module 2210, a data rearrangement module 2220, and a data transfer module 2230.

The measurement module 2210 that collects power status information may include a CPU_STATUS measurement module 2211, a POWER GATING_STATUS measurement module 2212, and a TEMP_STATUS measurement module 2213.

The CPU_STATUS measurement module 2211 may measure information about an operational status of a processor. For example, the CPU_STATUS measurement module 2211 may collect activation status information of multi-cores in the processor including the multi-cores. Also, the CPU_STATUS measurement module 2211 may collect operating frequency information of the processor. In more detail, the CPU_STATUS measurement module 2211 may collect activation status information of a plurality of little CPUs and big CPUs in the processor including the multi-cores.

The POWER GATING_STATUS measurement module 2212 may measure software power gating status information and hardware power gating status information. For example, the POWER GATING_STATUS measurement module 2212 may collect status information of software that instructs a gating operation on power that is supplied to the IP blocks IP1 2110-1, IP2 2110-2, . . . IPi 2110-i included in the hardware 2100 of an application processor. Also, the POWER GATING_STATUS measurement module 2212 may collect status information of a control signal for operating a gating circuit that supplies the power to the IP blocks IP1 2110-1, IP2 2110-2, . . . IPi 2110-i included in the hardware 2100 of the application processor.

The TEMP_STATUS measurement module 2213 may measure a temperature of at least one measurement point for the hardware 2100.

The data rearrangement module 2220 may sort and rearrange data about the power status information input from the measurement module 2210. For example, the data rearrangement module 2220 may sort and rearrange the data in accordance with a specification that is necessary for power profiling.

The data transfer module 2230 may transmit the data input from the data rearrangement module 2220 to the power profiling application module 2500 through the interface 2400.

The power measurement application module XyMon 2300 may include a measurement module 2310, a data rearrangement module 2320, and a data transfer module 2330.

The measurement module 2310 may measure power consumption of main power domains in the hardware 2100 of the application processor, and may generate power consumption measurement information corresponding to the measured power consumption. For example, the measurement module 2310 may measure a voltage or current of each IP of the IP block IP1 2110-1, IP2110-2, . . . IPi 2110-i, and may generate power consumption measurement information corresponding to the measured voltage or current.

The data rearrangement module 2320 may sort and rearrange data of the power consumption measurement information input from the measurement module 2310. For example, the data rearrangement module 2320 may sort and rearrange the data in accordance with a specification that is necessary for power profiling.

The data transfer module 2330 may transmit the data input from the data rearrangement module 2320 to the power profiling application module 2500 through the interface 2400.

The interface 2400 may perform data transmission/reception between the power monitoring application module PMon 2200 and the power profiling application module 2500, and may perform data transmission/reception between the power measurement application module XyMon 2300 and the power profiling application module 2500. For example, interfacing between the power monitoring application module PMon 2200 and the power profiling application module 2500 may be performed through a USB interface 2410.

Interfacing between the power measurement application module XyMon 2300 and the power profiling application module 2500 may be performed through an Ethernet interface 2420.

The inventive concepts of the present disclosure are not limited to the interfacing noted above and interfacing between the power monitoring application module PMon 2200 and the power profiling application module 2500 or interfacing between the power measurement application module XyMon 2300 and the power profiling application module 2500 may be performed through an ATA interface, a SATA interface, a PATA interface, a USB or SAS interface, a SCSI, an eMMC interface, a UFS interface, or an Ethernet interface.

The power profiling application module 2500 may include data parsing modules 2510, 2520, a data rearrangement, mathematical operations, and analysis module 2530, and a data viewer module 2540.

The data parsing module 2510 may process the data received from the power monitoring application module PMon 2200 into data that is necessary for power profiling. The data parsing module 2520 may process the data received from the power measurement application module XyMon 2300 into data that is necessary for power profiling.

The data rearrangement, mathematical operations, and analysis module 2530 may perform data rearrangement, mathematical operations, and analyses in order to generate power profiling reporting data by using the data obtained by the data parsing modules 2510 and 2520. For example, the data rearrangement, mathematical operations, and analysis module 2530 may perform the data rearrangement, the mathematical operation, and the analysis in order to calculate profiling reporting data that is necessary to form the screen images of FIGS. 7-10.

The data viewer module 2540 may perform graphics processing on the profiling reporting data generated by the data rearrangement, mathematical operations, and analysis module 2530 to obtain web type information or console type information. For example, the data viewer module 2540 may perform graphics processing to form the screen images of FIGS. 7-10.

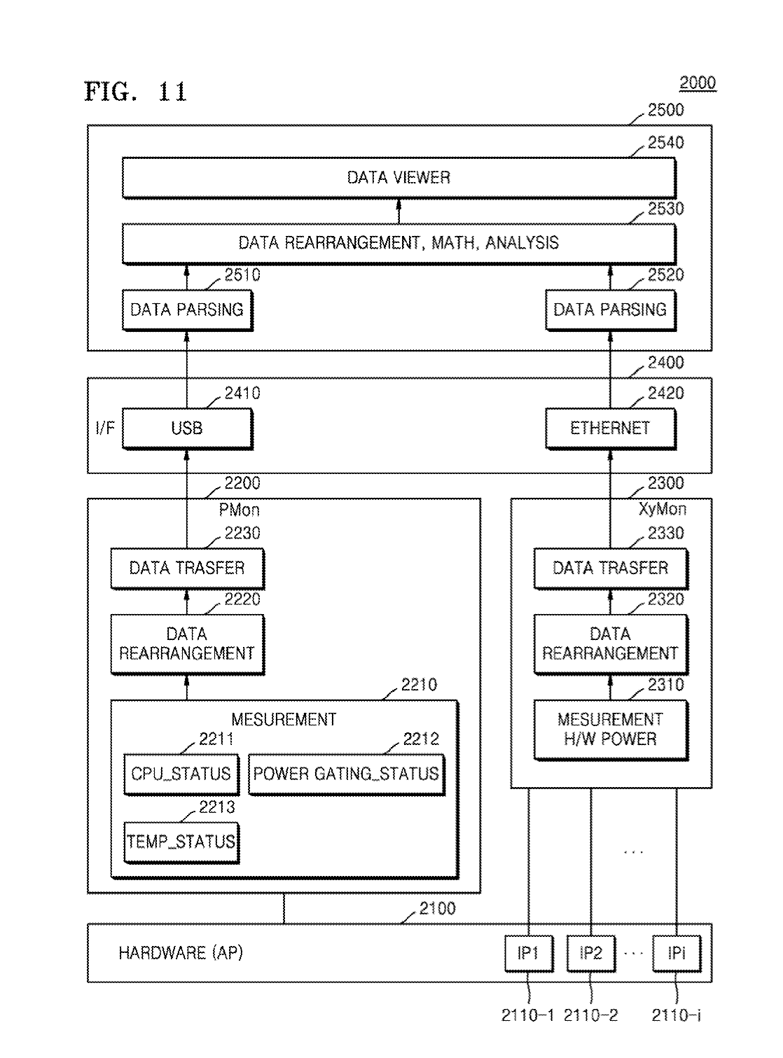

FIG. 12 is a diagram explaining power profiling performed by a power profiling system 3000, according to an exemplary embodiment.

FIG. 12 illustrates power profiling performed by the power profiling system 30000 including a target board 3100, a power measurement unit 3200, and a test management unit 3300.

A power monitoring application program PMon may be embedded in the target board 3100. For example, the target board 3100 may be the embedded system board 100 of FIG. 1.

A power measurement application program XyMon may be embedded in the power measurement unit 3200. For example, the power measurement unit 3200 and the test management unit 3300 may respectively include the same elements as those of the power measurement unit 200 and the test management unit 300 of FIG. 1.

Data or a signal flows during the power profiling performed by the power profiling system 3000 are as follows.

In operation S1, the test management unit 3300 may transmit test control information based upon a power test scenario to the target board 3100.

In operation S2, probes for measuring hardware power measurement terminals of the power measurement unit 3200 are connected to both terminals of a shunt resistor of a power line of power that is supplied to main power domains of the target board 3100.

In operation S3, the test management unit 3300 transmits power measurement start information to the power measurement unit 3200.

In operation S4, the target board 3100 transmits to the test management unit 3300 power status information that is collected by executing the power monitoring application program PMon in a process of performing an operation according to the test control information received from the test management unit 3300.

In operation S5, the power measurement unit 3200 transmits to the test management unit 3300 power measurement data of the main power domains calculated by executing the power measurement application program XyMon by using a voltage measured between the both terminals of the shunt resistor of the power line of the power that is supplied to the main power domains.

Accordingly, the test management unit 3300 can generate power test reporting information by performing power profiling, using the power status information and the power measurement data that are received from the target board 3100 and the power measurement unit 3200, respectively.

A power profiling method according to exemplary embodiments will now be explained.

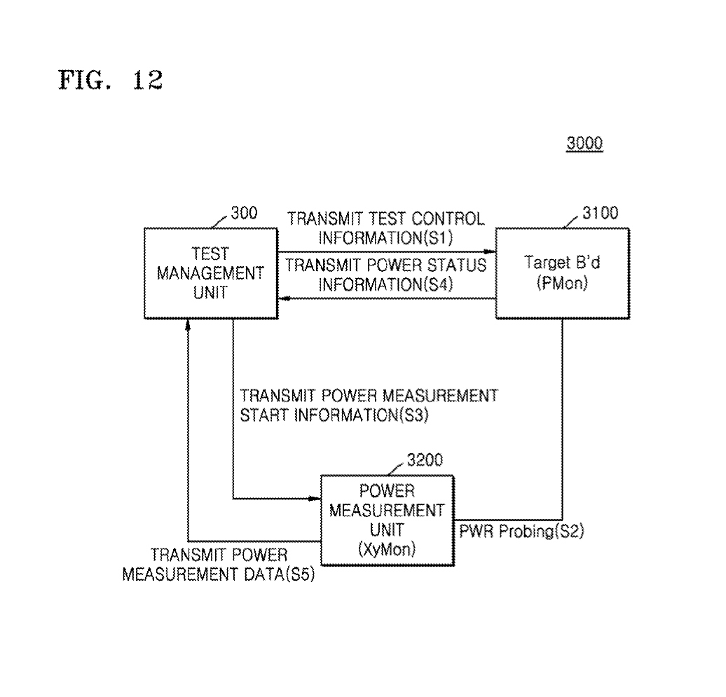

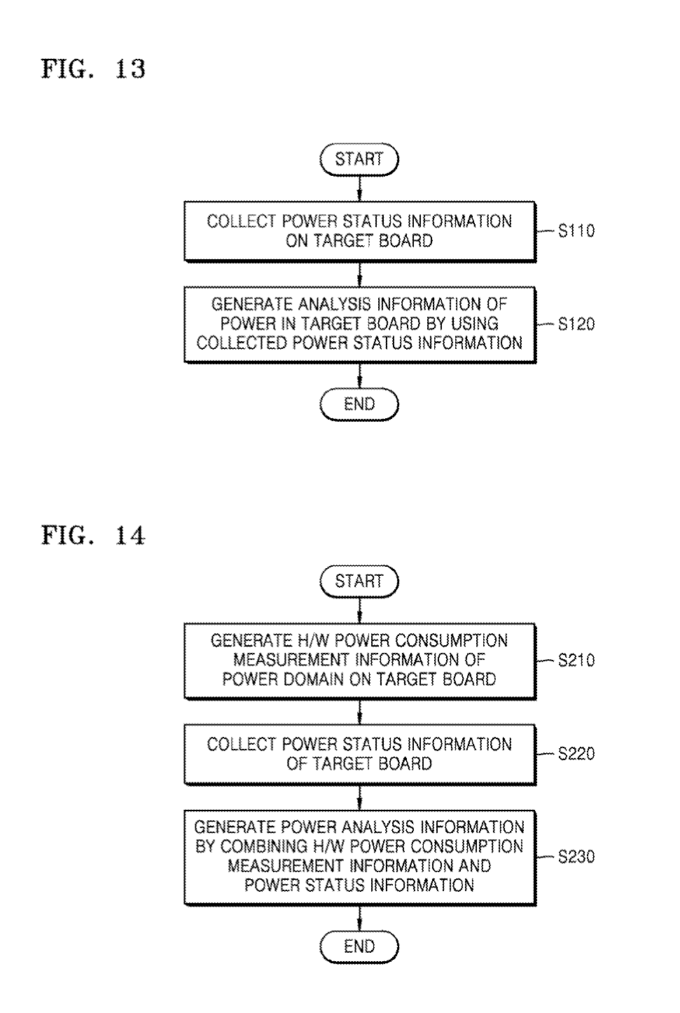

Power profiling methods of FIGS. 13 and 14 may be performed by the power profiling system 1000, 2000, or 3000 of FIG. 1, 11, or 12.

FIG. 13 is a flowchart of a power profiling method according to an exemplary embodiment.

In operation S110, the application processor 110 of a target board may collect power status information in the target board according to a test scenario. For example, the target board may be an embedded system board. In more detail, the application processor 110 may collect power status information indicating software and hardware statuses of a power domain that operates in the target board according to test control information received from the test management unit 300.

In operation S120, analysis information of the power of the target board may be generated using the power status information collected by the application processor 110. For example, the test management unit 300 may receive the collected power status information, and power analysis information may be generated based upon power profiling of the test management unit 300. Alternatively, the application processor 110 may directly generate power analysis information of the target board by processing and analyzing the power status information.

FIG. 14 is a flowchart of a power profiling method according to an exemplary embodiment.

In operation S210, a power profiling system may generate hardware power consumption measurement information of a power domain of a target board. For example, the power profiling system may measure a voltage between both ends of a shunt resistor of a power line of power supplied to main power domains of the embedded system board 100 that is the target board, may calculate current flowing in the power line of the power supplied to the main power domains from the measured voltage, and may generate hardware power consumption measurement information of the power domain by multiplying the calculated current with the voltage of the power line.

In operation S220, an application processor of the target board collects power status information in the target board according to a test scenario. For example, the application processor 110 of the embedded system board 100 that is the target board may collect power status information indicating software and hardware statuses of the power domain that operates in the embedded system board 100 according to test control information received from the test management unit 300.

In operation S230, analysis information of the power in the target board is generated by combining the power status information collected by the application processor 110 and the hardware power consumption measurement information of the power domain of the target board. For example, the test management unit 300 may receive the hardware power consumption measurement information of the power domain and the power status information, and may generate power analysis information of the target board by performing combination, mathematical operations, and analysis on the received hardware power consumption measurement information and power status information based upon power profiling.

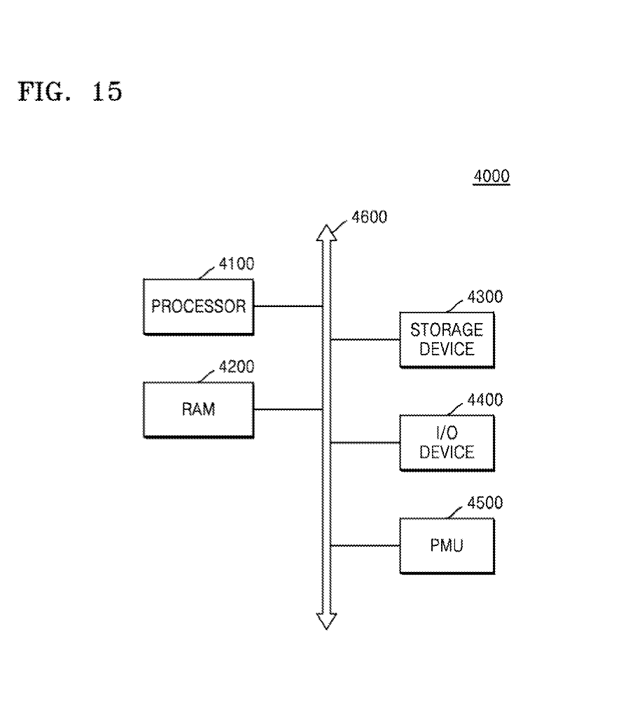

FIG. 15 is a block diagram illustrating an electronic apparatus 4000 to which an embedded system board is applied, according to an exemplary embodiment.

Referring to FIG. 15, the electronic apparatus 4000 may include a processor 4100, a RAM 4200, a storage device 4300, an input/output device 4400, a power management unit 4500, and a bus 4600.

Some or all elements of the electronic apparatus 4000 may be embedded in the embedded system board according to an exemplary embodiment.

Although not shown in FIG. 15, the electronic apparatus 4000 may further include ports that may communicate with a video card, a sound card, a memory card, or a USB, or other electronic devices. The electronic apparatus 4000 may be a personal computer, a notebook computer, a mobile device, a personal digital assistant (PDA), or a camera.

The bus 4600 may be a path through which data, commands, addresses, and control signals are transmitted between the elements of the electronic apparatus 4000.

The processor 4100 may perform specific calculations or tasks. For example, the processor 4100 may be a microprocessor or a CPU. The processor 4100 may communicate with the RAM 4200, the storage device 4300, the input/output device 4400, and the power management unit 4500 through the bus 4600 such as an address bus, a control bus, or a data bus. According to exemplary embodiments, the processor 4100 may be connected to an extension bus such as a PCI bus.

Data that is necessary to perform a process generated by the processor 4100 is loaded into the RAM 4200. The RAM 4200 may operate as a main memory, and may be a DRAM or an SRAM. For example, the power monitoring application program PMon may be stored in the RAM 4200.

The storage device 4300 that is a nonvolatile memory may be a flash memory.

The input/output device 4400 may include an input unit such as a keyboard, a keypad, or a mouse and an output unit such as a printer or a display.

The processor 4100 may perform mathematical operations or data processing corresponding to a user command input through the input/output device 4400. The processor 4100 may transmit to the storage device 4300 a command for reading data from the storage device 4300 or writing data to the storage device 4300 in order to perform the mathematical operation or data processing corresponding to the user command.

The storage device 4300 may perform a read operation or a write operation according to the command that is transmitted from the processor 4100.

Also, the processor 4100 may collect power status information by driving the power monitoring application program PMon.

The present inventive concepts can be implemented as a method, an apparatus, and a system. When the present inventive concepts are implemented in software, its component elements are code segments that execute necessary operations. Programs or code segments can be stored in processor readable media. Examples of the processor readable medium include electronic circuits, semiconductor memory devices, ROMs, erasable ROMs (EROMs), floppy disks, optical disks, hard disks, etc.

The system according to the one or more of the exemplary embodiments may be mounted by using various packages. For example, the system may be mounted by using packages such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic MetricQuad flat pack (MQFP), thin quad flatpack (TQFP), small outline (SOIC), shrink small outline package (SSOP), thin small outline (TSOP), thin quad flatpack (TQFP), system in package (SIP), multi chip package (MCP), wafer-level fabricated package (WFP), or wafer-level processed stack package (WSP).

While the inventive concepts of the present disclosure have been particularly shown and described with reference to exemplary embodiments thereof, they are provided for the purposes of illustration and it will be understood by those of ordinary skill in the art that various modifications and equivalent other embodiments can be made based upon the inventive concepts of the present disclosure. Accordingly, the true technical scope of the inventive concepts of the present disclosure is defined by the technical spirit of the appended claims.

What is claimed is:

1. A power profiling system comprising:
an embedded system board configured to collect power status information indicating software and hardware statuses according to test control information;
a power measurement unit connected to at least one power line of the embedded system board, the power measurement unit being configured to calculate power consumption measurement information of at least one power domain; and
a test management unit connected to the embedded system board and the power measurement unit, the test management unit being configured to receive the calculated power consumption measurement information, to receive the power status information, to transmit the test control information based upon power test scenario information to the embedded system board, and to generate power test reporting information by combining the power status information and the power consumption measurement information.

2. The power profiling system of claim 1, wherein the embedded system is configured to collect power status information including at least one among software and hardware power gating status information of a power domain that operates according to the test control information, status information of a central processing unit (CPU), and temperature information of at least one measurement point, and to transmit the collected power status information to the test management unit.

3. The power profiling system of claim 1, wherein the embedded system board comprises:
a power management unit configured to distribute a plurality of different powers to a plurality of power domains; and
an application processor configured to receive the plurality of different powers from the power management unit and to execute an application program for collecting the power status information,
wherein a shunt resistor is inserted into the at least one power line.

4. The power profiling system of claim 1, wherein the power measurement unit is configured to measure a voltage between both ends of a shunt resistor that is inserted into the at least one power line of the embedded system board and to calculate the power consumption measurement information of the at least one power domain that is connected to the at least one power line based upon the measured voltage.

5. The power profiling system of claim 1, wherein the test management unit is configured to process the power status information and the power consumption measurement information and to generate power analysis information of hardware and software of the embedded system board.

6. The power profiling system of claim 1, wherein the power test scenario information is configured to set a process of measuring power consumption of the at least one power domain.

7. The power profiling system of claim 1, wherein the embedded system board comprises a power management unit configured to supply and manage power needed by the embedded system board.

8. The power profiling system of claim 1, wherein the embedded system board comprises a processor including program codes and circuits for controlling operations of the embedded system board.

9. The power profiling system of claim 1, wherein the processor is configured to execute the power monitoring application program and to collect the power status information.

10. A power profiling system comprising:
an embedded system board comprising:
an application processor configured to collect power status information indicating software status and hardware status of at least one power domain among a plurality of power domains, the at least one power domain being configured to operate in the embedded system board; and
a power management unit configured to supply and manage power for the embedded system board;
a power measurement unit connected to at least one power line among a plurality of power lines of the embedded system board, the power measurement unit being configured to calculate power consumption measurement information of the at least one power domain; and
a test management unit connected to the embedded system board and the power measurement unit, the test management unit being configured to receive the calculated power consumption measurement information, to receive the power status information, to transmit a test control information based upon power test scenario information to the embedded system board, and to generate power test reporting information by combining the power status information and the power consumption measurement information,
wherein the power test scenario information is configured to set a process of measuring power consumption of the at least one power domain.

11. The power profiling system of claim 10, wherein the power management unit is configured to distribute a plurality of different powers to the plurality of power domains.

12. The power profiling system of claim 10, further comprising a plurality of shunt resistors, each of the plurality of shunt resistors being inserted into a respective power line among the plurality of power lines.

13. The power profiling system of claim 10, wherein the power measurement unit is configured to measure current that flows in the at least one power line and to calculate the power consumption measurement information using the measured current.

14. The power profiling system of claim 10, wherein the test management unit is configured to generate analysis information for detecting a power design error of software and hardware by processing the received power status information.

15. The power profiling system of claim 10, wherein the power management unit is configured to supply a plurality of pieces of power to the application processor.

16. A power profiling system comprising:
a target board configured to collect power status information of at least one power domain among a plurality of power domains, based upon power control information;
a power measurement unit connected to at least one power line among a plurality of power lines of the target board, the power measurement unit being configured to calculate power consumption measurement information of the at least one power domain; and
a test management unit configured to receive the power status information, to receive the power measurement information, to transmit the test control information based upon power test scenario information to the target board, and to transmit power measurement start information to the power measurement unit,
wherein the test management unit is configured to perform power profiling using the power status information and the power measurement information and to generate power test reporting information.

17. The power profiling system of claim 16, wherein the target board comprises:
a power management unit configured to distribute a plurality of different powers to the plurality of power domains; and
an application processor configured to receive the plurality of different powers from the power management unit and to execute an application program for collecting the power status information.

18. The power profiling system of claim 17, wherein the power management unit is configured to supply and manage power for the target board.

19. The power profiling system of claim 16, further comprising a plurality of shunt resistors, each of the plurality of shunt resistors being inserted into a respective power line among the plurality of power lines.

20. The power profiling system of claim 16, wherein the power status information comprises software status and hardware status of the at least one power domain, the at least one power domain being configured to operate in the target board.
